(19) United States
(12) Patent Application Publication
(10) Pub. No.: US 2005/0207374 A1
(43) Pub. Date: Sep. 22, 2005

(54) Method for cell modification in mobile communication system

(75) Inventors: Dragan Petrovic, Darmstadt (DE); Eiko Seidel, Darmstadt (DE)

Correspondence Address: STEVENS DAVIS MILLER & MOSHER, LLP, 1615 L STREET, NW, SUITE 850, WASHINGTON, DC, 20036, US

(73) Assignee: MATSUSHITA ELECTRIC INDUSTRIAL CO., LTD, Osaka (JP)

(21) Appl. No.: 10/516,183

(22) PCT Filed: Dec. 22, 2003
(86) PCT No.: PCT/JP03/16429

§ 371 Date: Nov. 30, 2004

(30) Foreign Application Priority Data
Dec. 20, 2002 (EP) 02028631.6

(51) Int. Cl. H04Q 7/00

(52) U.S. Cl. 370/331; 370/338

(57) ABSTRACT

S-RNC 1060 determines the need for the combined radio link addition and serving HS-DSCH cell change based on received measurement reports, and makes a decision for starting an active set update and cell change procedure (process 1070). After that, it notifies immediately to source base station (Source Node B) 1050 that the decision on active set update was done (signaling 2). Source Node B 1050 transmits an ACTIVATION TIME NEGOTIATION REQUEST message (signaling 3) to S-RNC 1060. S-RNC 1060 transmits an ACTIVATION TIME NEGOTIATION RESPONSE message (signaling 4) to Source Node B 1050. Source Node B 1050 knows activation time through this, and ceases capacity assignment for transmitting data to UE 1030, while transmitting buffered packets to UE 1030 with a priority made higher than those of other UEs.

### FIELD OF THE INVENTION

The present invention relates to a cell conversion method in radio resource management applicable to mobile communication systems and particularly to cellular systems.

### BACKGROUND ART

A common technique for error detection of non-real time services in communication systems is Automatic Repeat reQuest (ARQ) schemes that may be combined with Forward Error Correction (FEC). In ARQ, if an error is detected in PDU (Protocol Data Unit) by Cyclic Redundancy Check (CRC), the receiver requests the transmitter to send additional bits. In mobile communication, SAW (Stop-And-Wait) scheme and SR (Selective-Repeat) scheme are most often used among existing ARQ schemes. SAW scheme is a scheme in which a transmitter sends a PDU, and transmits the next PDU after confirming that there has been no repeat request from a receiver for a certain time period. SR scheme is a scheme in which a sequence number is assigned to a PDU, and retransmission is performed only for PDUs required to be retransmitted according to the presence/absence of a repeat request (ACK/NACK) corresponding to a sequence number returned from a receiver.

A PDU will be encoded before transmission at a transmitter. A scheme for achieving a more effective error control, through the combined use of encoding and ARQ, has now been studied. These are called as hybrid automatic repeat requests (HARQ), which are broadly categorized into the following three types. (e.g. S. Kallel, “Analysis of a type II hybrid ARQ scheme with code combining”, IEEE Transactions on Communications, Vol. 38#8, August 1990, and S. Kallel et al., “Throughput performance of Memory ARQ schemes”, IEEE Transactions on Vehicular Technology, Vol. 48#3, May 1999.)

These types are:
Type I: The erroneous PDU's are discarded and a new copy of that PDU is retransmitted and decoded separately. There is no combining of earlier and later versions of that PDU.
Type II: The erroneous PDU that needs to be retransmitted is not discarded, but is combined with some incremental redundancy bits provided by the transmitter for subsequent decoding. Retransmitted PDU's sometimes have higher coding rates and are combined at the receiver with the stored values. That means that only little redundancy is added in each retransmission.
Type III: This is the same as Type II except that every retransmitted PDU is now self-decodable. This implies that the PDU is decodable without the combination thereof with previous PDU's. This is useful if some PDU's are so heavily damaged that almost no information is reusable.

Another technique for link adaptation is Adaptive Modulation and Coding (AMC). A description of AMC can be found in 3GPP TSG RAN “Physical Layer Aspects of High Speed Downlink Packet Access” TR25.848V5.0.0 and A. Ghosh et al., “Performance of Coded Higher Order Modulation and Hybrid ARQ for Next Generation Cellular CDMA Systems”, Proceedings of VTC 2000.

The principle of AMC is to change the modulation and coding format in accordance with variations in the channel conditions, subject to system restrictions. The channel conditions can be estimated e.g. based on feedback from the receiver. In a system with AMC, users (mobile stations) in favorable positions e.g. users close to the cell site are typically assigned higher order modulation with higher code rates (e.g. 64 QAM with R=¾ Turbo Codes), while users in unfavorable positions e.g. users close to the cell boundary, are assigned lower order modulation with lower code rates (e.g. QPSK with R=½ Turbo Codes). In the following description, the different combinations of coding and modulation will be referred to as Modulation Coding Scheme (MCS) levels. Here, a transmission will be split into Transmission Time Intervals (TTI), whereas the MCS level could change for each TTI. TTI interval for HSDPA (High Speed Downlink Packet Access, refer to section 0) is equal to 2 ms. The main benefits of implementing AMC are: higher data rates are available for users in favorable positions which in turn increase the average throughput of the cell, and reduce interference variation due to link adaptation based on variations in the modulation/coding scheme instead of variations in transmit power.

The transmission format of a packet has yet another configurable parameter. By increasing the number of orthogonal codes in one TTI, the overall amount of information that can be transmitted is also increased. In the following text, the number of orthogonal codes and MCS will be referred to as Transmission Format Resource Combination (TFRC).

Packet scheduling is a resource management algorithm used for allocating transmission opportunities and transmission formats to the users admitted to a shared channel. Thus, a packet scheduling is used in packet-based mobile radio networks in combination with adaptive modulation and coding to maximize throughput e.g. by allocating transmission opportunities to the users in favorable channel conditions.

While the above description of the background art has mainly focused on retransmission protocols such as HARQ schemes, link adaptation techniques such as AMC and packet scheduling, a known field where such techniques could be applied will now be described in more detail with reference to the figures and drawings. More particularly, it will now be referred to the HSDPA (High Speed Downlink Packet Access) technique which is standardized in 3GPP (Third Generation Partnership Project) as a feature of UMTS (Universal Mobile Telecommunication System).

The concept diagram of the UMTS Architecture is shown in FIG. 1 (see e.g. H. Holma, et al., “WCDMA for UMTS”, John Wiley, 2000). The network elements are functionally grouped into Core Network (CN) 100, UMTS Terrestrial Radio Access Network (UTRAN) 110 and Mobile Station—User Equipment (UE) 120. UTRAN 110 is responsible for handling all radio-related functionality, while CN 100 is responsible for routing calls and data connections to external networks. The interconnections of these network elements are defined by open interfaces Iu and Uu as can be seen in the figure. It should be noted that UMTS system is modular and it is therefore possible to have several network elements of the same type.

FIG. 2 illustrates the architecture of UTRAN in more detail. A number of Radio Network Controllers (RNC) 220 and 230 are connected to CN 100. Each RNC 220, 230 controls one or several base stations (Node B's) 240-270 which in turn communicate with the UEs 120. An RNC 220, 230 controlling several base stations 240-270 is called Controlling Radio Network Controlling stations (C-RNC) for these base stations. A set of controlled base stations accompanied by their C-RNC is referred to as Radio Network Subsystem (RNS) 200, 210.

For each connection between User Equipment 120 and the UTRAN 110, one RNS 200, 210 functions as the Serving Radio Network Control System (S-RNS). S-RNS maintains the Iu connection with the Core Network (CN) 100. When required, Drift Radio Network Control System (D-RNS) 300 support the Serving RNS 310 by providing radio resources as shown in FIG. 3. Respective RNCs are termed Serving Radio Network Control Station (S-RNC) 310 and Drift Radio Network Control Station (D-RNC) 300. In the following, for simplicity, it is assumed that C-RNC and D-RNC are identical, so that only the abbreviations S-RNC or RNC will be used.

High Speed Downlink Packet Access (HSDPA) is a technique that is standardized in UMTS Release 5. It shall provide higher data rates in the downlink by introducing enhancements at the Uu interface such as adaptive modulation and coding. HSDPA relies on the HARQ Type II/III, rapid selection of UEs which are active on the shared channel, and adaptation of transmission format parameters according to the time varying channel conditions.

FIG. 4 shows the User Plane Radio Interface Protocol Architecture of HSDPA described in 3GPP TSG RAN TR 25.308, “High Speed Downlink Packet Access (HSDPA): Overall Description Stage 2”, V5.2.0. The HARQ protocol and scheduling functions belong to the MAC-hs sublayer which is distributed across base stations—Node B 240-270, and UE 120. It should be noted that an SR ARQ protocol based on sliding window mechanisms can be also established between RNC 220, 230 and UE 120 on the level of the RLC sublayer in an acknowledged mode. The service that is offered from the RLC sublayer for P to P (point-to-point) connection between CN 100 and UE 120 is referred to as Radio Access Bearer (RAB). Each RAB is subsequently mapped to a service offered from MAC layer. This service is referred to as Logical Channel (LC).

In the architecture of FIG. 4, HS-DSCH FP (High Speed Downlink Shared Channel Frame Protocol) is responsible for flow control between Node B 240-270 and RNC 220, 230. It determines the capacity (accommodation allocation) that can be granted to RNC 220, 230 for transmitting packets across the transport network based on requests obtained from RNC 220, 230. More specifically, the capacity is requested by CAPACITY REQUEST messages of HS-DSCH FP originating from S-RNC 310. The permission to transmit a certain amount of data over a certain period of time is granted by CAPACITY GRANT messages sent from Node B 240-270.

Parameters of the protocols are configured by signaling in the Control Plane. This signaling is governed by the Radio Resource Control (RRC) protocol for the signaling between the radio network (i.e. S-RNC 310 and UE 120) and by application protocols, the Node B Application Part (NBAP) on the Iub interface and the RNSAP (Radio Network Subsystem Application Part) on the Iur interface.

Before discussing in more detail the aspect of mobility management within UTRAN, some definitions will now be given according to 3GPP TR 21.905, “Vocabulary for 3GPP Specifications”, V 5.1.0. Some procedures connected to mobility management will be explained afterwards.

The term “radio link” is a logical association between single UE and a single UTRAN access point. Its physical realization comprises radio bearer transmissions.

A “handover” is defined as a change of MS (mobile station) connection from one radio bearer to another radio bearer (hard handover) with a temporary break in connection or inclusion/exclusion of a radio bearer to/from MS connection so that UE is constantly connected UTRAN (soft handover). Soft handover is specific for networks employing Code Division Multiple Access (CDMA) technology. Handover execution is controlled by the S-RNC in a mobile radio network.

An “active set” comprises a set of radio links simultaneously involved in a specific communication service between MS and radio network.

An “active set update procedure” modifies the active set of the communication between UE and UTRAN, see e.g. 3GPP TSG RAN WG2, “Radio Resource management Strategies”, V.4.0.0. The procedure comprises three functions: radio link addition, radio link removal and combined radio link addition and removal. The maximum number of simultaneous radio links is set to eight. New radio links are added to the active set once the pilot signal strengths of respective base stations exceed a predetermined first threshold relative to the pilot signal of the strongest base station within an active set. In addition, new radio links are deleted from the active set once the pilot signal strengths of respective base stations falls below a predetermined second threshold relative to the strongest member within an active set. The first threshold for radio link addition is typically chosen to be higher than the second threshold for the radio link deletion. Hence, addition and removal events form a hysteresis with respect to pilot signal strengths. Pilot signal measurements are reported to the network (S-RNC) from UE by means of RRC signaling. Before sending measurement results, some filtering is usually performed to average out the fast fading. Typical filtering duration is about 200 ms (see, e.g., 3GPP TSG RAN WG2, “Requirements for Support of Radio Resource Management (FDD)”, V.4.0.0) and it contributes to handover delay. Based on measurement results, S-RNC can decide to start the execution of one of the functions of the active set update procedure.

It is to be noted that the HSDPA architecture may be divided in two different aspects: (1) downlink transmitting entities of the retransmission protocols, RLC and MAC-hs, are located in S-RNC and Node B respectively, and (2) radio resource management algorithms, handover control and packet scheduling, are based on two independent measurements obtained from UE and are located in S-RNC and Node B respectively. These features have certain implications on mobility management and context preservation in HSDPA.

HS-PDSCH (High Speed Physical Downlink Shared CHannel) is a physical channel associated to HS-DSCH. The HS-PDSCH is transmitted with Associated Dedicated Physical Channel (A-DPCH). As a dedicated channel, A-DPCH is power controlled. The frame of HS-PDSCH (TTI of 2 ms) is chosen to be very short compared to that of dedicated channels (10 ms) to allow fast scheduling and link adaptation. Applying soft handover would cause the burden of scheduling operation for all Node B's within the active set. Even if this problem is solved, it would require extremely tight timing to provide the scheduling decision to all members of the active set. Therefore, soft handover is not supported for HS-PDSCH. Meanwhile, soft handover for A-DPCH is allowed, which means that a transmission can be made from more than one base station to a UE which combines obtained signals. The handover procedure related to a HSDPA radio link is called “serving HS-DSCH cell change”.

During the serving HS-DSCH cell change procedure, the role of the serving HS-DSCH link is transferred from one radio link to another radio link (refer to FIG. 5). The two cells involved in the procedure are denoted source HS-DSCH cell and target HS-DSCH cell. The “network-controlled serving HS-DSCH cell change” has the property that the network makes the decision on the target cell. In UMTS, this decision process is carried out in S-RNC. The cell change procedure can be initiated by the UE and it is then referred to as “UE-controlled serving HS-DSCH change procedure”. Another criterion for categorizing the cell change procedure is the one with respect to the serving HS-DSCH Node B.

The Node B controlling the serving HS-DSCH cell for a specific UE is defined as the “serving HS-DSCH Node B”. An “intra-Node B serving HS-DSCH cell change procedure” is the cell change procedure with source and target HS-DSCH cells being controlled by the same Node B. In “inter-Node B serving HS-DSCH cell change procedure”, source and target HS-DSCH cells are controlled by a different Node B. In FIG. 5, a serving HS-DSCH radio link related to UE 500 (L1) is transferred from a source HS-DSCH cell controlled by source HS-DSCH Node B 510 to a target HS-DSCH cell controlled by target HS-DSCH Node B 520. Incidentally, source HS-DSCH Node B 510 and target HS-DSCH Node B 520 are controlled by RNC 530.

It is further to be noted that “synchronized serving cell change procedures” allow the Node B and UE to simultaneously start transmitting/receiving signals after handover completion. Synchronization between the UE and the network is maintained with activation timers which are set by RRC entity in S-RNC. Due to unknown delays over Iub/Iur interfaces, processing and protocol delays, a suitable margin is assumed when determining activation timer setting. The margin also contributes to handover delay.

It should be noted that executing inter-Node B serving HS-DSCH cell change procedure also implies executing a “serving HS-DSCH Node B relocation procedure” and this is where the problems of HARQ context relocation arise.

Hereafter, an example of the signaling during a synchronized inter-Node B serving cell change procedure will now be discussed with reference to FIG. 6. It is noted that, in this FIG. 6, a number is assigned to each signaling in order to facilitate understanding. (see 3GPP TSG RAN, TR 25.308 “High Speed Downlink Packet Access (HSDPA):Overall Description Stage 2”, and 3GPP TSG RAN, TR 25.877 “High Speed Downlink Packet Access: Iub/Iur Protocol Aspects”, V.5.1.0)

In FIG. 6, it is assumed that decisions on starting active set update and cell change procedures are made in the S-RNC simultaneously.

First, assuming that mobile station (UE) 600 transmits a MEASUREMENT REPORT message (signaling 1) to S-RNC 630 via RRC signaling, S-RNC 630 then determines the need for the combined radio link addition and serving HS-DSCH cell change based on received measurement reports, and makes a decision for starting an active set update and cell change procedure (process 640).

As the first step, S-RNC 630 initiates the establishment of a new radio link for the dedicated channels to target base station (target Node B) 610 by transmitting a RADIO LINK SETUP REQUEST message (signaling 2) via the RNSAP/NBAP protocol. Target Node B 610 confirms the establishment of a radio link by transmitting a RADIO LINK SETUP RESPONSE message (signaling 3) to S-RNC 630 via the RNSAP/NBAP protocol. S-RNC 630 further transmits an ACTIVE SET UPDATE message (signaling 4) to UE 600 via the RRC protocol. The ACTIVE SET UPDATE message includes the necessary information for the establishment of the dedicated physical channels in the added radio link (but not the HS-PDSCH). The UE 600 will now add the new radio link, and return an ACTIVE SET UPDATE COMPLETE message (signaling 5) to the S-RNC 630 via RRC protocol. This completes the addition of a new radio link for a dedicated channel, and transmission and reception for dedicated channels in both of source and target cells are started (process 650).

The S-RNC 630 will now carry on with the next step of the procedure, which is the serving HS-DSCH cell change. For the synchronized serving HS-DSCH cell change, both the source base station (Source Node B) 620 and target base station 610 are first prepared for execution of the handover and the cell change at the activation time.

First, S-RNC 630 exchanges signaling messages with source Node B 620, including a MAC-hs release request (signaling 6), RADIO LINK RECONFIGURATION PREPARE (signaling 7), RADIO LINK RECONFIGURATION READY (signaling 8), and RADIO LINK RECONFIGURATION COMMIT (signaling 9) via NBAP/RNSAP protocols. It should be noted that the RADIO LINK RECONFIGURATION COMMIT message contains activation time information for the source Node B 620. The same set of messages are subsequently exchanged also between S-RNC 630 and target Node B 610 (signaling 10-12). The only difference in signaling intended for the source Node B 620 and target Node B 610 is that the S-RNC 630 informs the source Node B 620 to carry out the reset of the MAC-hs entity by a MAC-hs RELEASE REQUEST message of the NBAP/RNSAP protocol.

Finally, a PHYSICAL CHANNEL RECONFIGURATION message (signaling 13) is sent from S-RNC 630 to UE 600 via RRC signaling. It contains activation time information and a request for a MAC-hs reset to the UE 600. When the communication is established, the UE 600 responds with a PHYSICAL CHANNEL RECONFIGURATION COMPLETE message. This completes the addition of a new radio link for a shared channel, and the transmission and reception for shared channels in a target cell is started (process 660).

However, several problems may occur during the conventional inter-Node B serving cell change procedure, as will be described in more detail as follows. These problems may be summarized to relate to a packet loss and delay due to the cell change procedure, and to frequent cell changes due to the decision delay.

First, the packet loss problem due to the cell change procedure is discussed. As mentioned above, the serving HS-DSCH Node B relocation procedure involves also the problem of transferring the HARQ context from the source Node B to the target Node B. A direct physical interface in UTRAN between different base stations does not exist, and hence, the context transfer would have to be performed via the RNC. This would involve a significant transfer delay and that is why current solutions are limited to flushing the reordering buffer at the UE side and transferring all successfully received packets to a higher layer when the Node B relocation procedure has to be performed. Also, all packets buffered in the Node B have to be discarded once the serving Node B change is performed.

Assuming that the S-RNC is identical to the D-RNC and that the one way Iub delay equals 50 ms, the worst case Node B buffer occupancies per user and specific service (buffer memory area to be consumed) can be calculated as shown in the following table. The table depicts the Node B minimum buffer occupancies. Depending on a specific flow control algorithm employed on the Iub interface, the Node B buffer occupancy can vary.

| Service | 1.2 Mbps | 3.6 Mbps | 10 Mbps |
|---|---|---|---|
| Average Node B | 7500 | 22500 | 62500 |
| buffer | | | |
| occupancy | | | |
| (bytes) | | | |

Further, this data loss may also result in an additional delay. The delay problem due to the cell change procedure will now be discussed in more detail.

Apart from handover delays which are specific for all procedures and which may result from measurement and synchronization delays as shown above, there is an additional delay introduced by data loss. This delay is incurred due to compensation of lost packets.

For interactive services requiring high reliability of data transmission it is usual to configure the RLC sub-layer to work in an acknowledged mode. Since the entities of the RLC are placed in the RNC and UE, the RLC is transparent to the inter Node B serving cell change procedure. Thus, the packets lost from the Node B buffer and any missing packets detected in the sequence numbers of packets forwarded from the UE reordering buffer to a higher layer have to be compensated by RLC retransmissions. These will cause an additional delay mainly due to retransmitting these packets over interfaces of transport network.

This increased delay can trigger a spurious timeout of a reliable transport protocol (TCP) used for end-to-end (inter-end-terminal) transmissions and it may slow down the data rate of packets that are input to UTRAN due to congestion control mechanisms. This is described in, e.g., W. Stevens, “TCP/IP Illustrated”, vol. 1, Addison Wesley, 1999. Assuming the TCP segment size to be equal to 1500 bytes, the amount of data lost in Node B buffers (see above table) is in the range from 5 to 41 segments. After performing the cell change procedure, the channel conditions of the user will most likely be improved. However, due to the invoked TCP congestion control, the number of packets that are available for scheduling remains decreased and radio resources are not utilized efficiently.

Even more severe problems can occur in a network that has the RLC protocol configured in the unacknowledged mode, or in a conceptual network that has retransmission protocol entities just in the Node B and UEs. In this case all packets lost from the HARQ context would have to be retransmitted end-to-end thus causing even higher delay and inefficient usage of radio resources.

The packet loss and delay problems due to the cell change procedure have thus been described above in detail. Further problems may arise with frequent cell changes due to the decision delay.

As discussed above, the radio link addition function of the active set update procedure is triggered if the pilot signal of a certain Node B exceeds a certain threshold relative to the strongest pilot signal of the current active set. Thus, after completing the radio link addition for dedicated channels of a UE using the HSDPA radio link, it is possible that the new member cell can offer the best radio channel conditions to that UE. However, switching the HSDPA service to the new member cell simultaneously with the radio link addition does not necessarily have to be an optimal decision.

These are two possible cases for a conventional architecture: Either, the decision on triggering the radio link addition function of the active set update procedure and the serving cell change procedure is made by the S-RNC simultaneously (i.e., the serving cell change procedure is synchronized with the active set update procedure). Or, the decision on triggering the serving cell change procedure is made after the radio link addition function of the active set update procedure has been completed (i.e., the serving cell change procedure is not synchronized with the active set update procedure).

The problem may arise in particular when the serving cell change and the active set update procedures are not synchronized. If the decision on triggering the cell change procedure has been made with a significant delay, the channel conditions may change back by the time the procedure is complete. This would result in a continuous ping-pong behavior between cells during which it is not possible to schedule the user. Thus, in case the active set update and the serving cell change procedures are unsynchronized, it is useful to trigger the cell change procedure as soon as possible.

WO 01/35586 A1 discloses a method and an apparatus for network controlled handovers in a packet switched telecommunications network. Radio resource requirements for mobile stations accessing shared channel are stored on a permanent basis in base station system level. Thus, network-controlled handover can occur without the control of the element providing packets to the base station system.

WO 02/11397 A1 discloses a method for the header compression context control during a handover in mobile data communication networks. A header compressor is notified of a handover completion by the transmitter/receiver to resume operation according to the previously transferred context.

U.S. Pat. No. 6,414,947 B1 discloses a communication network and a method of allocating a resource therefor. Resource scheduling in soft handover is described.

### DISCLOSURE OF THE INVENTION

Given the above discussed problems with the prior art, it is the object of the invention to provide a cell change method and a corresponding cellular system that may overcome the negative impacts of data loss and delay during serving cell change procedures from one base station to another base station.

This object is solved by the invention as claimed in the independent claims.

Preferred embodiments are defined in the dependent claims.

The accompanying drawings are incorporated into and form a part of the specification for the purpose of explaining the principles of the invention. The drawings are not to be construed as limiting the invention to only the illustrated and described examples of how the invention can be made and used. Further features and advantages will become apparent from the following and more particular description of the invention, as illustrated in the accompanying drawings.

### BRIEF DESCRIPTION OF DRAWINGS

FIG. 1 illustrates the high level UMTS architecture according to the prior art;

FIG. 2 illustrates a conventional architecture of UTRAN;

FIG. 3 illustrates drift and serving radio network subsystems;

FIG. 4 illustrates the user plane radio interface architecture of HSDPA;

FIG. 5 illustrates the handover between source and target HS-DSCH cells;

FIG. 6 illustrates the inter-Node B serving HS-DSCH cell change signaling;

FIG. 7 illustrates a UE HSDPA architecture that can be used in compliance with the technique of the present invention;

FIG. 8 illustrates a Node B HSDPA architecture that can be used in compliance with the technique of the present invention;

FIG. 9 illustrates a feedback measurement transmission timing that can be used in compliance with the technique of the present invention;

FIG. 10 illustrates an RNC controlled inter-Node B serving cell change procedure with negotiation of the activation time, according to an embodiment of the present invention;

FIG. 11 illustrates another RNC controlled inter-Node B serving cell change procedure with negotiation of the activation time, according to an embodiment of the present invention;

FIG. 12 illustrates a Node B controlled inter-Node B serving cell change procedure without negotiation of the activation time, according to an embodiment of the present invention; and

FIG. 13 illustrates a Node B controlled inter-Node B serving cell change procedure with negotiation of the activation time, according to an embodiment of the present invention.

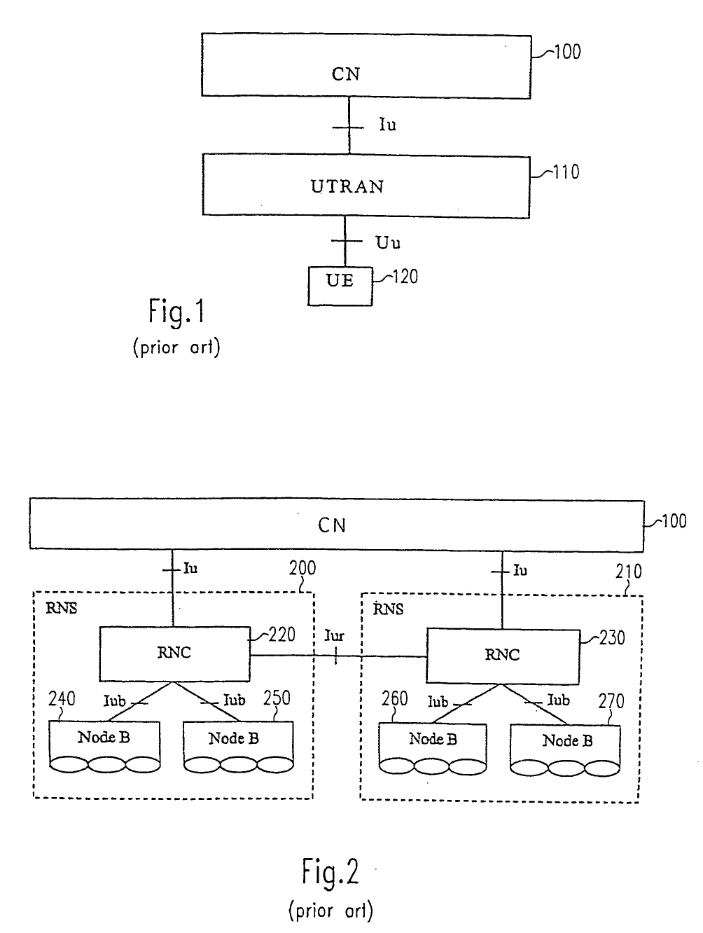

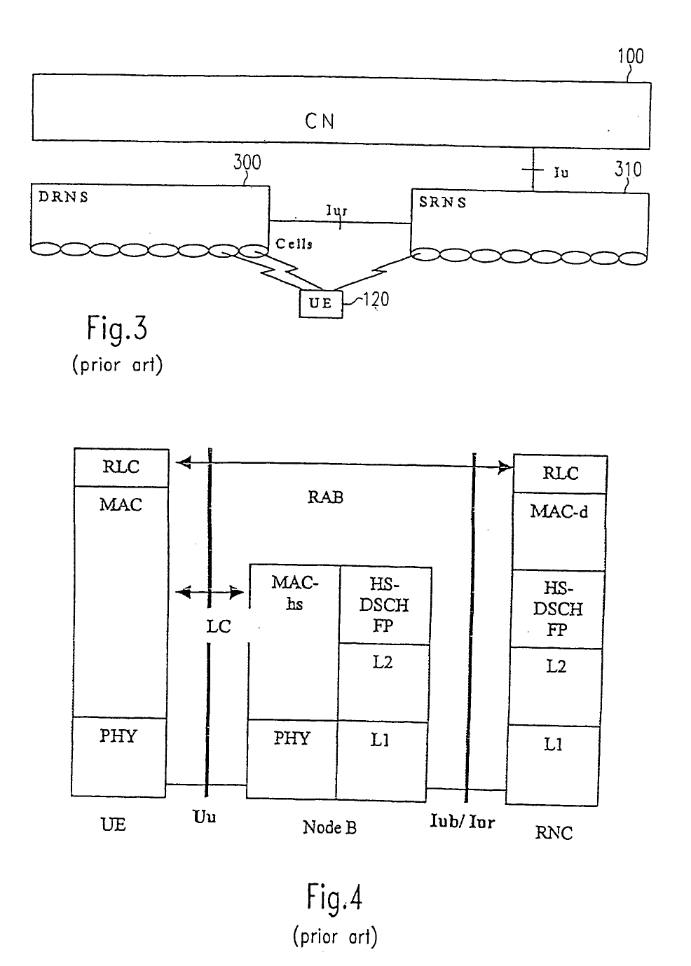

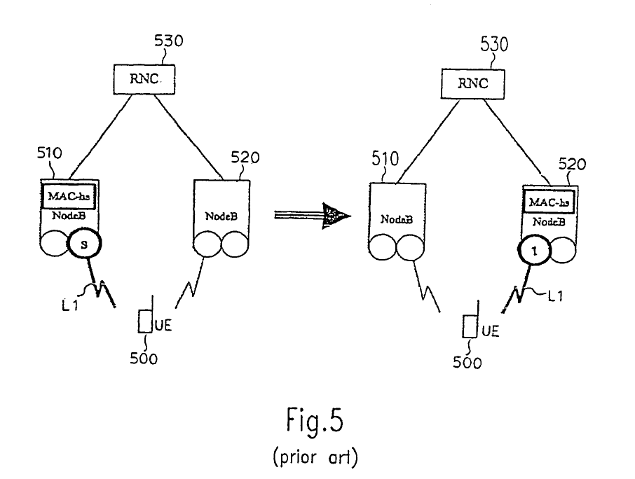

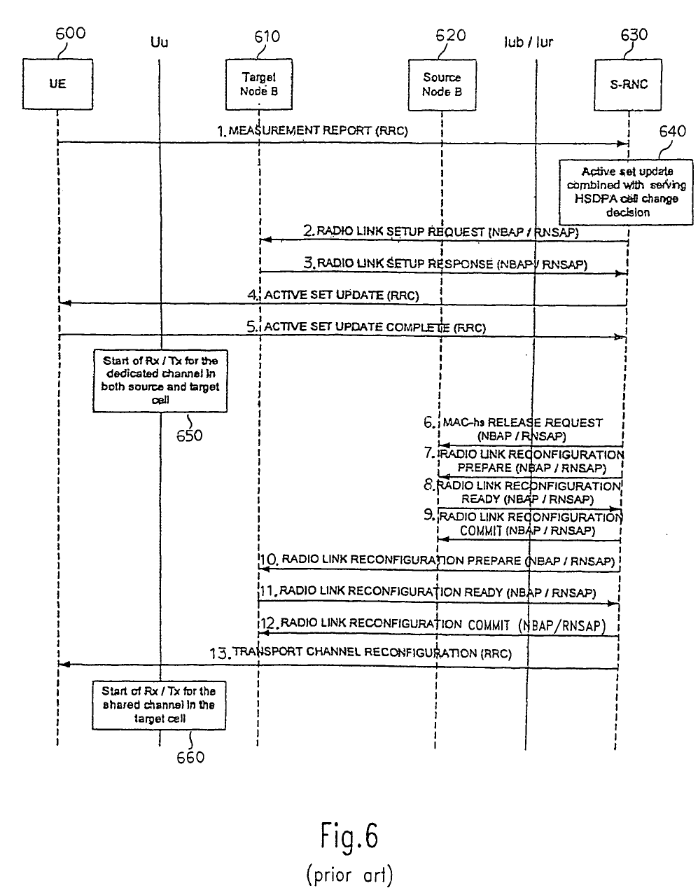

### BEST MODE FOR CARRYING OUT THE INVENTION

Embodiments of the present invention will be described below with reference to the accompanying drawings.

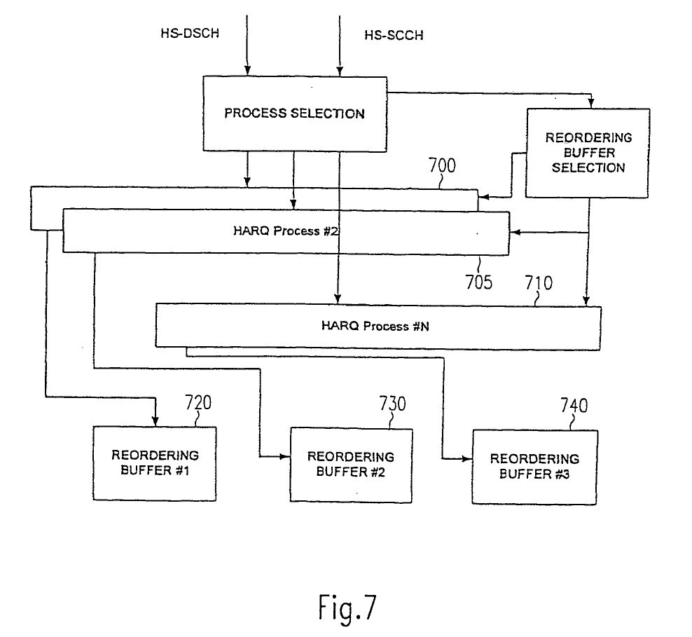

Before discussing in more detail the protocol context preservation according the invention, an HSDPA architecture will first be described with reference to FIGS. 7 to 9, in which the invention may be used.

First, with reference to FIG. 7, the UE HSDPA architecture is explained. It can be noted that each HARQ process 700, 705, 710 is assigned a certain amount of soft buffer memory for combining the bits of the packets from outstanding retransmissions. Once a packet is received successfully, it is forwarded to the reordering buffer 720, 730, 740 providing the in-sequence delivery to the RLC sublayer. According to this architecture, the reordering queue may be tied to a specific priority.

It should be noted that the available soft buffer size may depend on UE radio access capability parameters such as those described in 3GPP TSG RAN, “Physical Layer Aspects of High Speed Downlink Packet Access”, TR25.848, V5.0.0. The processing time of the UE for a certain MCS level and a minimum inter-TTI interval (minimum time between two successive scheduling instants) can also be considered as capability parameters. These are signaled from the UE to the RNC by the RRC protocol and further from the RNC to the Node B.

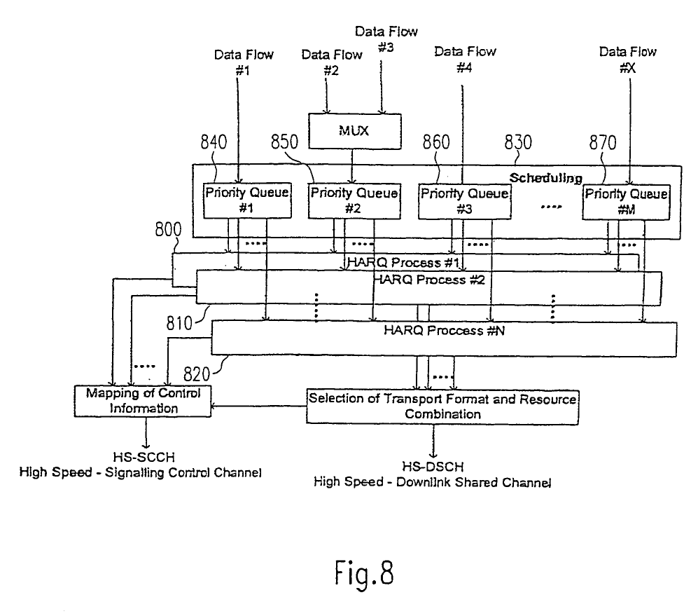

Next, with reference to FIG. 8, the Node B HSDPA architecture is explained. There are many different data flows (logical channels) with data packets to be transmitted from the Node B to the UE. The set of HARQ transmitting and receiving entities, located in the Node B and the UE respectively, may be referred to as HARQ process. The maximum number of HARQ processes 800, 810, 820 per UE may be predefined. These data flows can have different QoS (e.g. delay and error requirements) and may require different configuration of HARQ instances. The scheduler will consider these parameters in allocating resources to different UE's. The scheduling function 830 controls the allocation of shared channel (HS-DSCH: High Speed Downlink Shared CHannel) to different users or to data flows of the same user, in the current MCS level in one Time Transmission Interval (TTI), and manages existing HARQ instances for each user. A data flow or even a particular packet of a data flow may have a different priority. Therefore the Data Packets can be queued in different priority queues 840, 850, 860, 870. Different data flows with similar QoS requirements may also be multiplexed together (e.g. Data Flow #2 and #3). Besides the high speed downlink shared channel that carries the data packets there is control data which is mapped onto the HS-SCCH (High Speed Shared Control CHannel). This could carry data such as the HARQ process ID, the modulation scheme, code allocation, transport format etc that is needed by the receiver to correctly receive, demodulate, combine and decode the packets.

It should be noted that there may be a number of packets waiting to be scheduled for the initial transmission to some of the available HARQ processes and also a number of packets pending for retransmissions. Further, the state of HARQ processes depends on whether they are available for accepting packets for initial transmission or they still retransmit the pending packets that are to be combined in UE. In the following description, this information will be referred to as “HARQ context” or “MAC-hs protocol context of a UE”.

In particular, the HARQ context may include: packets waiting for an initial transmission, packets waiting for retransmission, and the state of HARQ processes.

Power control commands referring to the A-DPCH obtained from the UE can be used as an index for estimating channel quality.

Another possibility to estimate the channel quality is by means of a channel quality indicator (CQI) obtained from uplink signaling.

Referring now to the HSDPA uplink signaling, this signaling may be carried out by means of the dedicated uplink feedback channel transmitted by the UE. The CQI transmitted on this channel contains a TFRC (Transport Format Resource Combination). The primary benefit of requesting a TFRC compared to signaling the channel state is that it can deal with different UE implementations resulting in different performance for a certain transport format at a specific channel state. A low TFRC value corresponds to bad channel conditions (lower level modulation, low code rate) and a high TFRC value maximizes throughput for good channel conditions. The Node B does not necessarily have to follow the request of the UE. A UE may use certain criteria to determine which transmission format it is able to receive in given channel conditions. All the coded bits will be mapped onto the HSDPA UL-DPCCH (Uplink Dedicated Physical Control CHannel). In UMTS FDD (Frequency Division Duplex), the HS-DSCH related uplink signaling can use DPCCH-HS with a spreading factor=256 that is code multiplexed with the existing dedicated uplink physical channels.

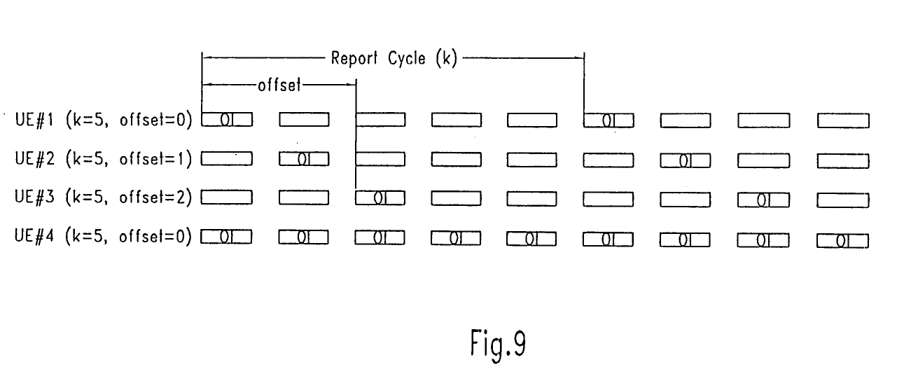

The transmission cycle and timing for channel quality indicator is determined by UTRAN and signaled, by the control plane. Measurement feedback cycle k has a possible value of {1, 5, 10, 20, 40, 80} TTI. The larger the value of k the smaller is the signaling overhead in the uplink at the expense of decreased scheduling performance in the downlink. The set of values for measurement feedback offset l has yet to be determined. An illustration of feedback measurement transmission timing is given in FIG. 9.

While an environment has so far been described in which the invention may be performed, the context preserving technique of the present invention will now be discussed in more detail. As will be apparent from the following description, a part of the HARQ context of the source Node B (i.e. packets pending for initial transmission and packets pending for retransmission) will be preserved. The steps to achieve this, may be one or more of the following approaches:
(1) Inter-Node B serving cell change recognizing a flow control in HS-DSCH FP
(2) Inter-Node B serving cell change recognizing a schedule function in MAC-hs
(3) Additional control plane signaling messages within NBAP/RNSAP protocols

As will be apparent from the more detailed description below, the invention is applicable to both synchronized and unsynchronized active set update and serving cell change procedures. The following embodiments may be grouped into a category of synchronized active set update and inter-node B serving cell change procedures, and a category of unsynchronized active set update and inter-node B serving cell change procedures. In case of synchronized procedures, it is assumed that serving cell change and active set update procedures are decided upon simultaneously by S-RNC and carried out at the same time instant. This time instant is denoted as activation time. In other words, the activation time is the time at which to activate an active set update process and a handover.

In the category of synchronized procedures, RNC controlled serving cell changes without changing the activation time may be distinguished from those with changing the activation time. Similarly, the unsynchronized procedures may be divided into Node B controlled serving cell changes without and with changing the activation time.

1. Synchronized Active Set Update and Inter-Node B Serving Cell Change Procedures

In the case of RNC controlled serving cell changes without changing the activation time, two approaches may be distinguished. In the first approach, an intelligent flow control is performed in the RNC, whereas in the second approach, an intelligent flow control and scheduling function is performed in the Node B. It is to be noted that these two approaches may be combined.

Intelligent flow control in RNC means that the RNC should stop sending CAPACITY REQUEST messages to the source Node B once the decision on active set update and serving cell change procedures has been made.

Intelligent flow control and scheduling function in the Node B may encompass the following steps. The S-RNC informs the Node B on the decision and on the activation time. Then, the Node B flow control (in HS-DSH FP) denies all CAPACITY REQUESTS from the user. Further, the Node B scheduling function (in MAC-hs) gives a higher priority than those of other UEs to packets from the user pending for an initial transmission/retransmission in order to expedite their delivery before the activation time.

The technique of RNC controlled serving cell changes with changing the activation time is similar to the RNC controlled serving cell changes without changing the activation time, as described above, but differs therefrom in that the Node B may propose a new value for the activation time after being notified by the S-RNC on the initial value. The S-RNC may decide either to accept this value or to retain the old one. In the following, it is referred to this procedure as activation time negotiation procedure.

The flow control and scheduling function can then be described as follows. First, the S-RNC informs the Node B on the decision and on the activation time. The activation time negotiation procedure is carried out by exchanging NBAP/RNSAP ACTIVATION TIME NEGOTIATION REQUEST and RESPONSE messages between Node B and RNC. Further, the Node B flow control (in HS-DSH FP) denies all CAPACITY REQUESTS from the user. Moreover, the Node B scheduling function (in MAC-hs) gives a higher priority than those of other UEs to packets from the user pending for an initial transmission/retransmission in order to expedite their delivery before reaching the agreed activation time.

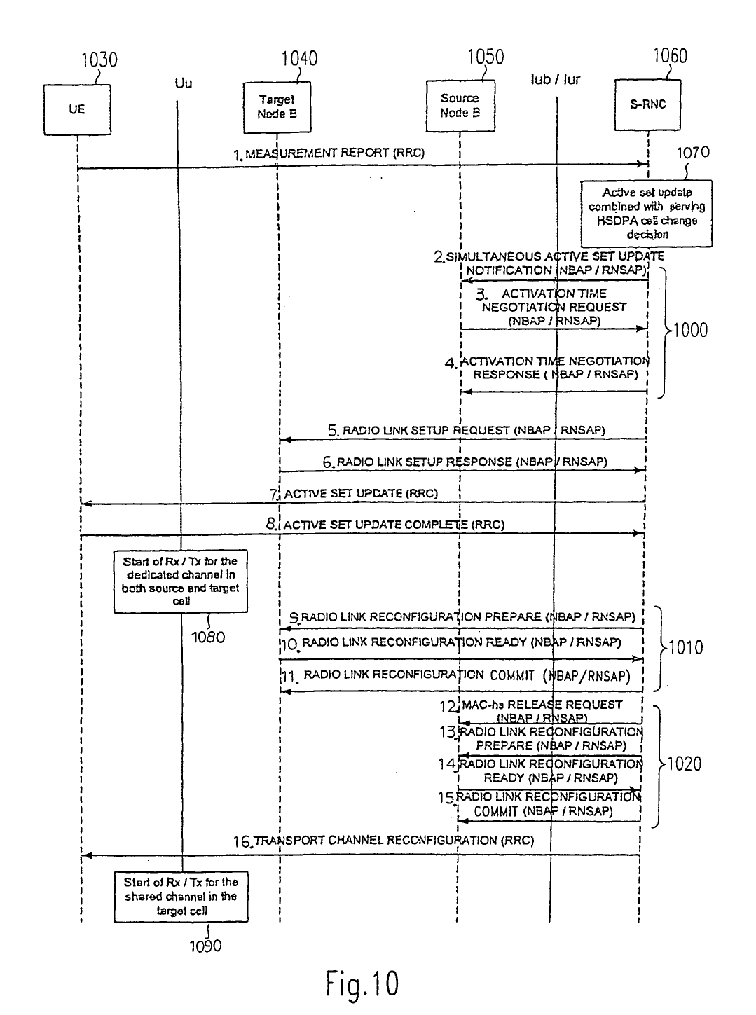

A signaling example for RNC controlled serving cell change with changing activation time will now be described with reference to FIG. 10. It is noted that, in this FIG. 10, a number is assigned to each signaling in order to facilitate understanding.

First, assuming that mobile station (UE) 1030 transmits a MEASUREMENT REPORT message (signaling 1) to S-RNC 1060 via RRC signaling, S-RNC 1060 then determines the need for the combined radio link addition and serving HS-DSCH cell change based on received measurement reports, and makes a decision for starting an active set update and cell change procedure (process 1070).

After that, S-RNC 1060 notifies immediately to source base station (Source Node B) 1050 via RNSAP/NBAP protocol that the decision on active set update was done (signaling 2). Source Node B 1050 transmits an ACTIVATION TIME NEGOTIATION REQUEST message (signaling 3) to S-RNC 1060 via the RNSAP/NBAP protocol. S-RNC 1060 transmits an ACTIVATION TIME NEGOTIATION RESPONSE message (signaling 4) to Source Node B 1050 via the RNSAP/NBAP protocol. Through process 1000 of the above signaling 2-4, because source Node B 1050 is notified of activation time immediately after the deciding of the start of serving Node B cell change procedures, it is possible to cease capacity assignment in source Node B for transmitting data to UE 1030, while it is possible for source Node B 1050 to transmit buffered packets to UE 1030 with a higher priority than those of other UEs. Consequently, it is possible to reduce packet losses in comparison with prior art.

Next, S-RNC 1060 initiates the establishment of a new radio link for the dedicated channels to target base station (target Node B) 1040 by transmitting a RADIO LINK SETUP REQUEST message (signaling 5) via the RNSAP/NBAP protocol. Target Node B 1040 confirms the establishment of a radio link by transmitting a RADIO LINK SETUP RESPONSE message (signaling 6) to S-RNC 1060 via the RNSAP/NBAP protocol. S-RNC 1060 further transmits an ACTIVE SET UPDATE message (signaling 7) to UE 1030 via the RRC protocol. The ACTIVE SET UPDATE message includes the necessary information for the establishment of the dedicated physical channels in the added radio link (but not the HS-PDSCH). The UE 1030 will now add the new radio link, and return an ACTIVE SET UPDATE COMPLETE message (signaling 8) to the S-RNC 1060 via RRC protocol. This completes the addition of a new radio link for a dedicated channel, and transmission and reception for dedicated channels in both of source and target cells are started (process 1080).

The S-RNC 1060 will now carry on with the next step of the procedure, which is the serving HS-DSCH cell change. For the synchronized serving HS-DSCH cell change, both the source base station 1050 and target base station 1040 are first prepared for execution of the handover and the cell change at the activation time.

First, S-RNC 1060 exchanges signaling messages (process 1010) with target Node B 1040, including a RADIO LINK RECONFIGURATION PREPARE (signaling 9), RADIO LINK RECONFIGURATION READY (signaling 10), and RADIO LINK RECONFIGURATION COMMIT (signaling 11) via NBAP/RNSAP protocols. S-RNC 1060 exchanges signaling messages (process 1020) with source Node B 1050, including a MAC-hs release request (signaling 12), RADIO LINK RECONFIGURATION PREPARE (signaling 13), RADIO LINK RECONFIGURATION READY (signaling 14), and RADIO LINK RECONFIGURATION COMMIT (signaling 15) via NBAP/RNSAP protocols. Consequently, the CMAC-HS-Release-REQ primitive (HS-DSCH related open request primitive between MAC-RRC) 1020 will then be sent after the target Node B has been informed of the activation time through process 1010.

Finally, a PHYSICAL CHANNEL RECONFIGURATION message (signaling 16) is sent from S-RNC 1060 to UE 1030 via RRC signaling. It contains activation time information and a request for a MAC-hs reset to the UE 1030. When the communication is established, the UE 1030 responds with a PHYSICAL CHANNEL RECONFIGURATION COMPLETE message. This completes the addition of a new radio link for a shared channel, and the transmission and reception for shared channels in a target cell is started (process 1090).

2. Unsynchronized Active Set Update and Inter-Node B Serving Cell Change Procedures

In this case it is assumed that the Node B decides upon the serving cell change procedure after the active set has been updated. This approach applies in case the active set update and the serving cell change procedures are unsynchronized.

The higher layer signaling for measurements requires much time because the signaling needs to reach all the way to the S-RNC. Therefore, a fast cell site selection can be Node B-initiated based on physical layer measurements (CQI, power control commands for A-DCH, transmission power). This contributes to decreasing the cell change procedure decision delay and avoiding a ping-pong effect. Since the Node B makes a decision on initiating the cell change procedure it can adjust the scheduling algorithm so that a loss of the context is prevented. The procedure may be describes as follows.

First, the S-RNC notifies the source Node B that an active set update procedure will be carried out. From that moment on, the Node B has the permission to initiate a serving cell change procedure with a newly added Node B being the target Node B. The Node B may then monitor the channel quality and/or the transmission power used in the channel, e.g., by monitoring the time average of CQI reports, power control commands for A-DCH, and/or the transmission power, until it decides on the cell change procedure. The Node B then informs the S-RNC that the cell change procedure should be initiated (e.g. by a NBAP/RNSAP CELL CHANGE PROCEDURE NOTIFICATION message). The Node B flow control function (in HS-DSH FP) stops admitting any additional packets from RNC for the particular user. Further, the Node B scheduling function (in MAC-hs) gives a higher priority than those of other UEs to packets from the user pending for an initial transmission/retransmission in order to expedite their delivery before the activation time.

With respect to the activation time setting, it was already mentioned that the unsynchronized procedures may be divided into Node B controlled serving cell changes without and with changing the activation time. Thus, there are two possibilities for determining the activation time in Node B controlled serving cell change methods.

Firstly, the activation time may be set by the Node B and communicated to the S-RNC within a NBAP/RNSAP CELL CHANGE PROCEDURE NOTIFICATION message. In this case, the method is referred to as Node B controlled serving cell change without changing the activation time.

Secondly, the activation time may be set by the S-RNC and communicated to the Node B after the CELL CHANGE PROCEDURE NOTIFICATION message (NBAP/RNSAP ACTIVATION TIME NOTIFICATION message). The Node B may initiate and carry out a negotiation procedure for the activation time by using the same set of messages as described above. In this case, the method is referred to as Node B controlled serving cell change with changing the activation time.

Thus, various embodiments have been described that may be used to preserve the context in an inter-base station handover. The following table gives a short overview.

| | | | Relation | |
|---|---|---|---|---|
| | | | of active | |
| | | | set update | |
| | | | and | |
| | | | serving | |
| | HS-DSCH | | cell | |
| | FP flow | MAC-hs | change | Activation |
| | control | scheduling | procedures | time |
| RNC | In RNC or | Not used | Synchronized | Determined |
| controlled | Node B or | in case | | by RNC |
| serving | in both | flow | | |
| cell | network | control | | |
| change | elements | is in RNC | | |
| without | | only, | | |
| changing | | otherwise | | |
| activation | | Yes | | |
| time | | | | |
| RNC | Yes, in | Yes | Synchronized | Initially |
| controlled | Node B | | | set by |
| serving | | | | RNC and |
| cell | | | | negotiated |
| change | | | | between |
| with | | | | RNC and |
| changing | | | | source |
| activation | | | | Node B |
| time | | | | |
| Node B | Yes, in | Yes | Unsynchronized | Determined |
| controlled | Node B | | | by |
| serving | | | | Node B |
| cell | | | | |
| change | | | | |
| without | | | | |
| changing | | | | |
| activation | | | | |
| time | | | | |
| Node B | Yes, in | Yes | Unsynchronized | Initially |
| controlled | Node B | | | set by |
| serving | | | | RNC and |
| cell | | | | negotiated |
| change | | | | between |
| with | | | | RNC and |
| changing | | | | source |
| activation | | | | Node B. |
| time | | | | |

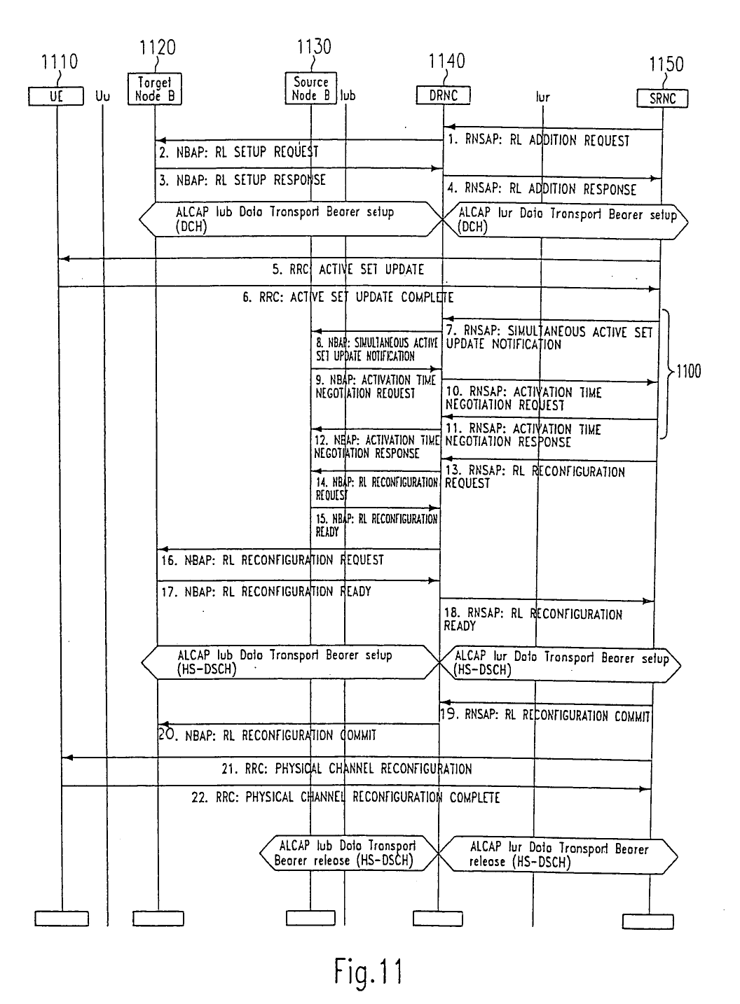

Referring now to FIG. 11, a more detailed embodiment of RNC controlled serving cell changes with changing activation time will now be discussed. It is noted that, in this FIG. 11, a number is assigned to each signaling in order to facilitate understanding.

First, the S-RNC 1150 decides there is a need for an addition of a radio link, which would become the new serving HS-DSCH cell. As a first step the S-RNC 1150 requests the D-RNC 1140 to establish the new radio link without the HS-DSCH resources by transmitting a RADIO LINK ADDITION REQUEST message (signaling 1) to the D-RNC 1140.

The D-RNC 1140 then allocates radio resources for the new radio link and requests the target Node B 1120 to establish a new radio link by transmitting a RADIO LINK SETUP REQUEST message (signaling 2) including the necessary parameters for DCH establishment.

The target Node B 1120 allocates resources, starts physical layer reception on the DPCH 1140 on the new radio link and responds with a RADIO LINK SETUP RESPONSE message (signaling 3).

The D-RNC 1140 responds to the S-RNC 1150 by transmitting a RADIO LINK ADDITION RESPONSE message (signaling 4). The DCH transport bearer is then established.

The S-RNC 1150 then prepares an ACTIVE SET UPDATE message (signaling 5) and transmits it to the mobile station (UE) 1110. The message includes an identification of the radio link to add.

The UE 1110 will now add the new radio link to its active set and return an ACTIVE SET UPDATE COMPLETE message (signaling 6) to the S-RNC 1150.

Signaling 7 to 12 are used to perform the activation time negotiation process 1100 according to the embodiment. The S-RNC 1150 transmits an RNSAP SIMULTANEOUS ACTIVE SET UPDATE NOTIFICATION message to the D-RNC 1140 which will react thereto by transmitting an NBAP SIMULTANEOUS ACTIVE SET UPDATE NOTIFICATION message to the Node B 1130 (signaling 7 and 8). The Node B 1130 will the transmit an NBAP ACTIVATION TIME NEGOTIATION REQUEST (signaling 9) to the D-RNC 1140 which will react thereto by transmitting an RNSAP ACTIVATION TIME NEGOTIATION REQUEST to the S-RNC 1150 (signaling 10). In response thereto, the S-RNC 1150 transmits an RNSAP ACTIVATION TIME NEGOTIATION RESPONSE message to the D-RNC 1140 which will react thereto by transmitting an NBAP ACTIVATION TIME NEGOTIATION RESPONSE message to the Node B 1130 (signaling 11 and 12). Thus, the activation time negotiation process 1100 of FIG. 11 substantially corresponds to the process 1000 of FIG. 10.

As the next step, the S-RNC 1150 prepares a RADIO LINK RECONFIGURATION REQUEST message (signaling 13) which is transmitted to the D-RNC 1140. The message indicates the target HS-DSCH cell.

If it is assumed that the source and target HS-DSCH cells are controlled by different Node B's, the D-RNC 1140 requests the source HS-DSCH Node B 1130 to perform a synchronized radio link reconfiguration using the RADIO LINK RECONFIGURATION REQUEST message (signaling 14), removing its HS-DSCH resources for the source HS-DSCH radio link. The source Node B 1130 then returns a RADIO LINK RECONFIGURATION READY message (signaling 15) to the D-RNC 1140.

The D-RNC 1140 requests the target HS-DSCH Node B 1120 to perform a synchronized radio link reconfiguration using the RADIO LINK RECONFIGURATION REQUEST message (signaling 16), adding HS-DSCH resources for the target HS-DSCH radio link. The message also includes necessary information to setup the HS-DSCH resources in the target HS-DSCH cell, including a D-RNC selected HS-DSCH UE identity number. The source HS-DSCH Node B 1130 returns a RADIO LINK RECONFIGURATION READY message (signaling 17). The D-RNC 1140 then returns a RADIO LINK RECONFIGURATION READY message (signaling 18) to the S-RNC 1150. The message includes scrambling code for target HS-DSCH cell, and HS-DSCH UE identity.

The HS-DSCH transport bearer to the target HS-DSCH Node B 1120 is now established. The S-RNC 1150 proceeds by transmitting RADIO LINK RECONFIGURATION COMMIT message (signaling 19) to the D-RNC 1140 including an S-RNC selected activation time in the form of a CFN.

The D-RNC transmits RADIO LINK RECONFIGURATION COMMIT messages (signaling 20) to the source HS-DSCH Node B 1130 and the target HS-DSCH Node B 1120 including the activation time. At the indicated activation time, the source HS-DSCH Node B 1130 stops and the target HS-DSCH Node B 1120 starts transmitting on the HS-DSCH to the UE 1110.

The S-RNC 1150 also transmits a PHYSICAL CHANNEL RECONFIGURATION message (signaling 21) to the UE1110. The message includes activation time, MAC-hs reset indicator, serving HS-DSCH radio link indicator, HS-SCCH set info and HS-DSCH UE identity.

Finally, at the indicated activation time, the UE 1110 resets MAC-hs, stops receiving HS-DSCH in the source HS-DSCH cell and starts HS-DSCH reception in the target HS-DSCH cell. The UE 1110 then returns a PHYSICAL CHANNEL RECONFIGURATION COMPLETE message (signaling 22) to the S-RNC. The HS-DSCH transport bearer to the source HS-DSCH Node B 1130 is released.

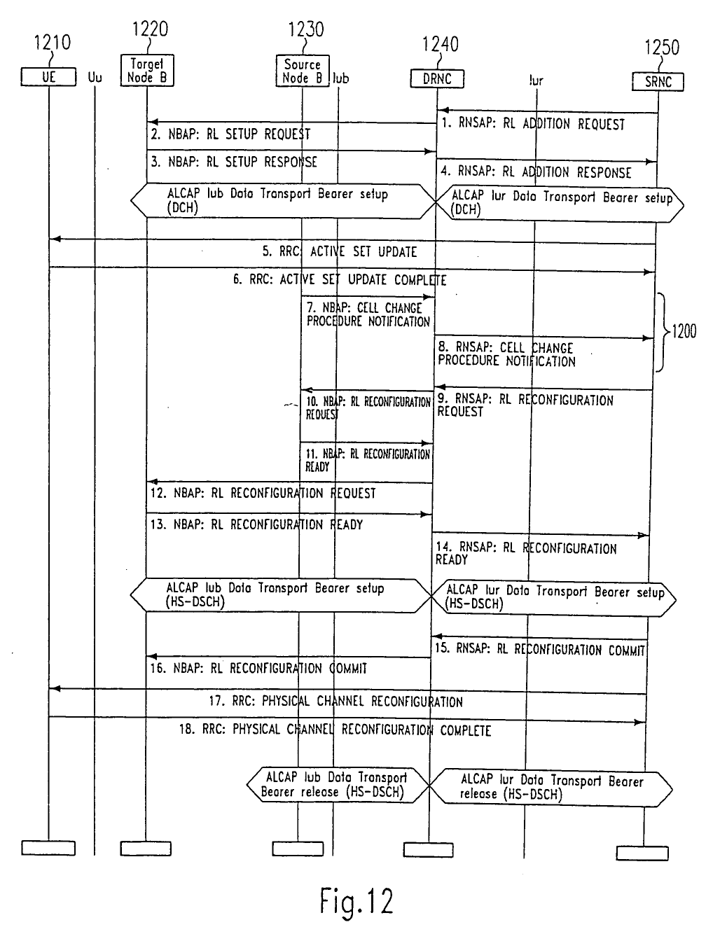

Turning now to FIG. 12, an embodiment of a Node B controlled serving cell change without changing the activation time is depicted. Most of the signaling is the same as described above with reference to FIG. 11. In addition, the procedure 1200 is provided. The source Node B 1230 transmits an NBAP CELL CHANGE PROCEDURE NOTIFICATION message (signaling 7) to the D-RNC 1240 which generates an RNSAP CELL CHANGE PROCEDURE NOTIFICATION message (signaling 8) therefrom and transmits same to the S-RNC 1250. By means of these messages, the source Node B 1230 can control the serving cell change as described in more detail above.

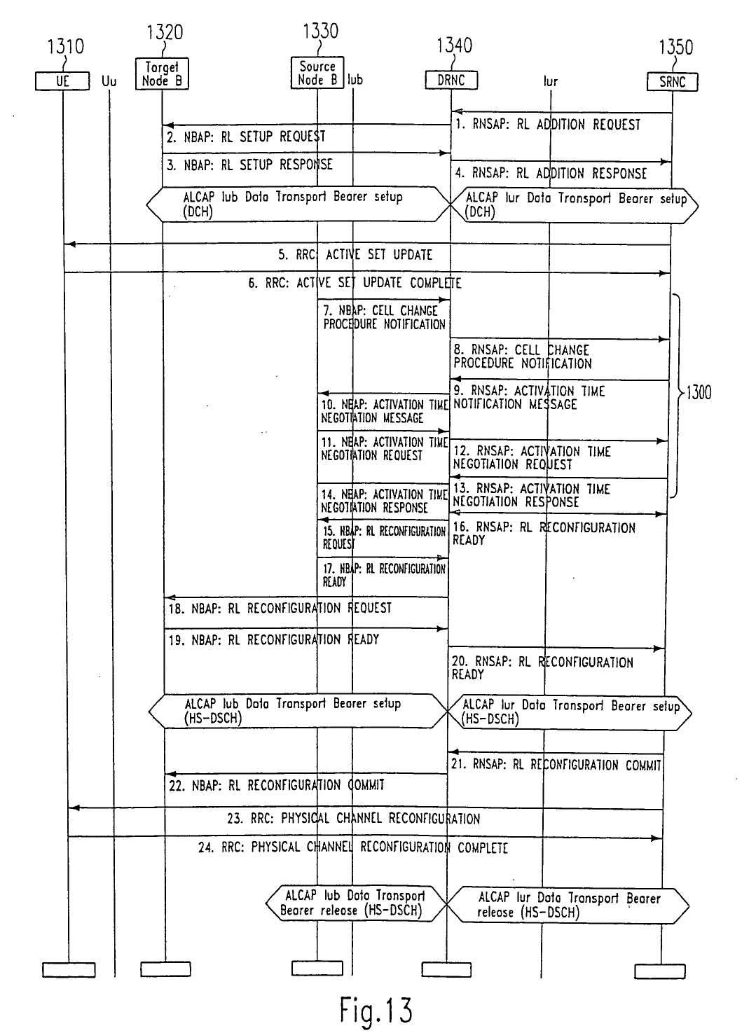

An embodiment of a Node B controlled serving cell change with changing the activation time is depicted in FIG. 13. In this embodiment, signaling 7 and 8 correspond to those of FIG. 12. In addition thereto, the process 1300 comprises activation time related signaling 9 to 14. In detail, the S-RNC 1350 transmits an RNSAP ACTIVATION TIME NOTIFICATION message (signaling 9) to the D-RNC 1340, and at the D-RNC 1340, a corresponding NBAP message is generated and transmitted to the source Node B 1330 as signaling 10. The following signaling 11 to 14 correspond to signaling 9 to 12 of FIG. 11, so that it is referred to the respective description above.

As apparent from the foregoing, the invention relates to radio resource management in communication systems and is particularly applicable to cellular systems. When mobile station (MS) changes its serving Node B, the protocol context (state variables and buffered packets) may be preserved to improve latency and network resource utilization.

The invention may be related to ARQ Type II and Type III schemes, where the received (re)transmissions are combined. Thus, the technique of the various embodiments can be considered as a link adaptation technique since the redundancy can be adapted according to the channel conditions. It is to be noted that the various embodiments can further be considered as an improved packet scheduling technique where the scheduler may be assumed to operate on TTI basis.

Further, it was already apparent that the invention is particularly applicable to HSDPA. Although most of the presented embodiments refer to HSDPA, the invention is not restricted to this system. Therefore the data transmission does not necessarily depend on a particular radio access scheme. The invention is applicable to any mobile communication system with distributed architecture.

This specification is based on the European Patent Application No. EP02028631.6 filed on Dec. 20, 2002, entire content of which is expressly incorporated by reference herein.

### INDUSTRIAL APPLICABILITY

The present invention is suitably applicable to a mobile communication system, and particularly to a cellular system.

1. A cell change method of changing a radio link of a mobile station from a source cell controlled by a first base station to a target cell controlled by a second base station in a cellular system in which the first and the second base stations are controlled by a radio network control station, wherein the first and the second base stations and/or the radio network control station perform a radio resource management and a flow control, said cell change method comprising the steps of:
determining that a cell change of the radio link of the mobile station is to be performed; and
blocking capacity assignments to the first base station for data transmissions to the mobile station before having established a radio link to the target cell.

2. The cell change method according to claim 1, wherein the radio network control station blocks capacity assignment to the first base station by stopping the sending of a capacity request message to the first base station in a cellular system in which the radio network control station performs the flow control.

3. The cell change method according to claim 1, wherein capacity assignment to the first base station is blocked by the first base station's stopping the sending of a capacity grant message to the radio network control station in response to a capacity request message related to the mobile station in a cellular system in which the first base station performs the radio resource management and the flow control.

4. The cell change method according to claim 1, wherein, when blocking capacity assignment to the first base station, a priority of data of the mobile station pending for an initial transmission/retransmission is made higher than those of other mobile stations in scheduling.

5. The cell change method according to claim 1, wherein the resource management process further comprising:
when an update process for the radio network control station's updating an active set of a radio link related to the mobile station is in synchronization with a cell change process of a radio link of the mobile station, a step of determining to perform an update process simultaneously with determining to perform a cell change;
a step of transmitting an update notification message from the first radio network control station to the first base station indicating that a cell change is to be performed simultaneously with the update process; and
transmitting a time notification message from the first radio network control station to the first base station indicating an activation time at which to activate the update process and the cell change.

6. The cell change method according to claim 5, further comprising the step of: deciding in the first base station and the radio network control station a timing at which to perform cell change process, wherein said step of deciding comprises: a step of transmitting a message from the first base station to the radio network control station after having received the time notification message for negotiating a different activation time; and
a step of transmitting a message from the radio network control station to the first base station in response to said message.

7. The cell change method according to claim 1, wherein the resource management process further comprising:
when an update process for the radio network control station's and/or the first base station's updating an active set of a radio link related to the mobile station is not in synchronization with a cell change process of a radio link of the mobile station, a step of determining whether an update process is performed or not at the radio network control station; and
a step of determining that the first base station performs cell change process when it is determined that the update process is to be performed.

8. The cell change method according to claim 7, wherein the step of determining that a cell change process is to be performed comprises the step of: monitoring in the first base station the quality of a shared channel, a transmission power or a power control command used in an associated dedicated physical channel.

9. The cell change method according to claim 7, further comprising the step of deciding in the first base station a timing at which to perform a cell change process, wherein said step of deciding comprises the steps of:
determining in the first base station an activation time at which to activate the cell change; and
transmitting a time notification message from the first base station to the first radio network control station indicating the activation time.

10. The cell change method according to claim 7, further comprising the step of deciding in the first radio network control station and/or the first base station a timing at which to perform a cell change procedure, wherein said step of deciding comprises the steps of:
determining in the radio network control station an activation time at which to activate the update process;
transmitting a time notification message from the radio network control station to the first base station indicating the activation time; and
transmitting a message from the first base station to the radio network control station and a message from the radio network control station to the first base station for negotiating a different activation time.

11. The cell change method according to claim 1, wherein said cellular system is a UMTS system, the first and the second base stations and the radio network control stations are comprised in the UTRAN, and said flow control process is a function of the HS-DSCH FP.

12. The cell change method according to claim 11, wherein, when blocking capacity assignment to the first base station, the first base station makes a priority of data of the mobile station pending for an initial transmission/retransmission higher than those of other mobile stations in scheduling in MAC-hs sublayer.

13. The cell change method according to claim 11 or claim 12, wherein, the radio network control station and the first base station exchange control plane signaling messages within NBAP/RNSAP protocols to perform an activation time negotiation.

14. A cellular system comprising:
a mobile station;
a first base station in a source cell;
a second base station in a target cell;
a radio network control station for controlling the first and the second base station;
wherein the radio network control station and/or the first base station comprise a flow control unit and a radio resource management function for determining that a cell change is to be performed, said cell change being for transferring a radio link of the mobile station from the source cell to the target cell, wherein the flow control unit is adapted to block capacity assignments to the first base station for data transmissions to the mobile station before having established a radio link to the target cell.
